(19) United States
(12) Patent Application Publication
(10) Pub. No.: US 2026/0031669 A1
(43) Pub. Date: Jan. 29, 2026

(54) SNAP WEDGE SPRING-BACK RETENTION CONFIGURATION AND RELATED METHOD FOR RETAINING MECHANICAL MAGNETS IN ELECTRIC MACHINES

(71) Applicant: FCA US LLC, Auburn Hills, MI (US)

(72) Inventors: Reza Ghafoori-Ahangar, Auburn Hills, MI (US); Dhafar Al-Ani, Auburn Hills, MI (US)

(21) Appl. No.: 18/786,779

(22) Filed: Jul. 29, 2024

(51) Int. Cl. H02K 1/28; H02K 1/276

(52) U.S. Cl. CPC H02K 1/28; H02K 1/276

(57) ABSTRACT

An electric machine for powering an electric vehicle includes a rotor configured to rotate relative to a stator to drive a rotor shaft and at least one drive wheel of the electric vehicle, the rotor defining at least a first rotor slot configured to receive a magnet therein. A plurality of first rotor laminations are stacked upon each other, each having a first configuration. A second rotor lamination is located between adjacent first rotor laminations of the plurality of first rotor laminations, the second configuration including a retention mechanism defined thereon that extends generally into the first rotor slot. The retention mechanism is configured to deform as a result of engagement with the magnet during insertion of the magnet into the second rotor slot creating a retention load onto the magnet in a first direction parallel to the rotor slot and a second direction perpendicular to the rotor slot.

### FIELD

The present application relates generally to electric drive modules for electric vehicles and, more particularly, to a snap wedge spring-back retention configuration and related method for retaining mechanical magnets in electric machines.

### BACKGROUND

Different types of electric vehicles, including mild hybrid electric vehicles (mHEV's), plug-in hybrid electric vehicles (PHEV's), battery electric vehicles (BEV's), and extended-range battery electric vehicles (EREV's), rely on electric machines for propulsion as a main source of torque, which generates the necessary power for vehicle propulsion. Electrical machines that include permanent magnet in the rotor′ electric steel lamination stacks is called an interior permanent magnet (IPM). In some instances, particularly at higher speed electric machines, it can be challenging to retain the magnets in the rotor lamination stacks. Prior art methods of retaining magnets in the rotor laminations include mold injection, adhesives, mold transfer, wavy springs, punching and other retention strategies that each present various drawbacks. In this regard, while existing retention configurations can be satisfactory, there remains a need for improvement in the relevant art.

### SUMMARY

In accordance with one example aspect of the invention, an electric machine for powering an electric vehicle includes a rotor configured to rotate relative to a stator to drive a rotor shaft and at least one drive wheel of the electric vehicle, the rotor defining at least a first rotor slot configured to receive a magnet therein. Depending upon the electromagnetic design, there are many different rotor slot configurations such as, but not limited to, single V-shape, double V-shape, V-shape with bar, double V-shape with bar, etc. A plurality of first rotor laminations are stacked upon each other, each having a first pattern. A second rotor lamination is located between adjacent first rotor laminations of the plurality of first rotor laminations, the second rotor lamination having a second pattern distinct from the first pattern, the second pattern including a retention mechanism defined thereon that extends generally into the first rotor slot. The retention mechanism is configured to deflect or deform as a result of engagement with the magnet during insertion of the magnet into the second rotor slot creating a retention load onto the magnet in a first direction parallel to the rotor slot and a second direction perpendicular to the rotor slot, the retention load retaining the magnet within the rotor slot.

In examples, the retention mechanism comprises a retention body and the wedge that cooperatively provide the retention load between the magnet and the rotor laminations.

In addition to the foregoing, the rotor lamination defines an edge at the rotor slot, wherein the retention mechanism deflects from a first pre-magnet insertion position to a second post-magnet insertion position causing the retention load of the magnet against the edge.

In addition to the foregoing, the magnet is inserted into the rotor slot thereby slidably advancing along the retention mechanism causing the retention snap wedge mechanism to deflect.

In addition to the foregoing, the magnet is shaped such that load is exclusively transmitted onto the retention mechanism of the second rotor lamination and not any of the plurality of first rotor laminations.

In examples, the snap wedge provides a spring-back force onto the magnet.

In accordance with one example aspect of the invention, a method is provided for assembling a rotor configured for use in an electric machine for powering an electric vehicle, the rotor configured to rotate relative to a stator to drive a rotor shaft and at least one drive wheel of the electric vehicle. The rotor defines at least a first rotor slot configured to receive a magnet therein. The method includes: arranging a plurality of first rotor laminations stacked upon each other, each having a first configuration; arranging a second rotor lamination between adjacent first rotor laminations of the plurality of first rotor laminations, the second rotor lamination having a second configuration distinct from the first configuration, the second configuration including a retention snap wedge mechanism defined thereon that extends generally into the first rotor slot; inserting a magnet into the rotor slot; and wherein insertion of the second magnet causes the retention mechanism to deflect as a result of engagement with the magnet during insertion of the magnet into the rotor slot creating a retention load onto the magnet in a first direction parallel to the rotor slot and a second direction perpendicular to the rotor slot, the retention load retaining the magnet within the rotor slot.

In examples, the retention mechanism includes a retention body and the wedge that cooperatively provide the retention load between the second magnet and the rotor.

In addition to the foregoing, the rotor lamination defines an edge at the rotor slot, wherein the retention mechanism deflects from a first pre-magnet insertion position to a second post-magnet insertion position causing the retention load of the magnet against the edge.

In addition to the foregoing, the magnet is inserted into the rotor slot thereby slidably advancing along the retention snap wedge mechanism causing the snap wedge to deform or deflect.

In addition to the foregoing, the magnet is shaped such that load is exclusively transmitted onto the retention mechanism of the second rotor lamination and not any of the plurality of first rotor laminations.

In examples, the retention snap wedge mechanism provides a spring-back force onto the magnet.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain having an electric drive module that incorporates a mechanical arrangement for retaining magnets in a rotor lamination stack, in accordance with the principles of the present application;

FIG. 2 is a rotor laminations stack and magnet assembly used in an electric machine of the electric drive module shown in FIG. 1, in accordance with the principles of the present application;

FIG. 3 is a detail view of a rotor lamination showing a gap between the magnet and rotor slot, in accordance with the principles of the present application;

FIG. 4 is a schematic illustration of a wedge shaped snap retention mechanism that is urged between the magnet and the rotor lamination at the gap without and with deflection;

FIG. 5 is a plan view of a first lamination pattern in the rotor, the first lamination presenting a geometry that does not interface with a magnet inserted into a respective rotor slot;

FIG. 6 is a plan view of a second lamination pattern in the rotor wherein a snap is deflected as a result of insertion of the magnet into the respective rotor slot, the snap having a wedge such that insertion of the magnet causes the wedge to deflect into a gap between the magnet and the rotor slot edge securing the magnet in place;

FIG. 7 is a partial perspective view of a section of a rotor lamination stack according to additional features of the instant application;

FIG. 8 is a plan view of a first rotor lamination and a second rotor lamination showing a retention mechanism disposed on a second rotor lamination prior to insertion of a magnet in a pre-deformed position;

FIG. 9 is a plan view of the first rotor lamination and second rotor lamination of FIG. 8 and shown with the retention mechanism disposed on the second rotor lamination deformed subsequent to insertion of the magnet; and

FIG. 10 is a plan view of a rotor lamination stack shown with the retention mechanism on the second rotor lamination before deflection in solid line and after deflection (due to magnet interaction) in phantom line.

### DETAILED DESCRIPTION

As noted above, electric machines are used in various types of electrified vehicles to generate the necessary power for vehicle propulsion. Electrical machines include rotor lamination stacks that incorporate magnets disposed within slots defined in the rotor lamination stacks. In some circumstances, it can be challenging to retain the magnets in the rotor lamination stacks. For example, during assembly on a production line it is important to adequately retain the magnets in the rotor lamination stacks. Furthermore, during operation of the rotor in an electric machine, adequate retention is essential for accounting for the centrifugal force seen during rotation. Prior solutions for retaining magnets in the rotor lamination slots included adhesive, mold injection, mold transfer, retaining sleeves, wavy springs, tab and groove and punching.

In some existing arrangements, the magnets in the rotor laminations stack are retained in place by biasing members such as wavy springs that are inserted between the magnets and the rotor slot edges. These wavy springs are formed of a metal having shape memory and can be inserted as ductile flat sheets at low temperature, becoming stiff wavy springs at normal ambient temperatures. The flexibility of the wavy spring allows it to absorb minor shocks and vibrations, protecting the magnet from damage due to sudden impacts or movements. Wavy springs can have a limited load-bearing capacity compared to the present disclosure, which could be a concern in applications requiring high retention force. Over time, repeated compression and expansion of the wavy spring can lead to wear and fatigue, potentially reducing the effectiveness of the wavy spring. Furthermore, the design of the wavy spring requires additional space around the magnet, which could be a limitation in compact or tight-fitting applications. Moreover, wavy springs are sensitive to changes in temperature or humidity, which could affect their performance and reliability in certain environments.

In other prior arrangements, crush ribs are incorporated into selected rotor laminations which undergo deformation upon magnet insertion. Tab and groove configurations provide secure retention on the magnet and minimize the risk of movement of the magnet. Tabs and grooves have a lower load-bearing capacity compared to the instant disclosure, which could be a concern in applications requiring high speed. There are multiple lamination layouts for incorporating tabs and grooves making the assembly process complex.

In another prior art configuration, a rotor slot's edge undergoes plastic deformation, effectively retaining the magnet through this deformation. The punching method can cause damage to the magnet or surrounding components if not executed with precision or if excessive force is applied. Although there is generally good process control during punching, there is potential for pre-stress and load on the magnets. Depending on the material and thickness of the stack, punched retention features are limited to the surface of the stack and does not consider retention of the magnets within the stack depth. Moreover, aligning and positioning the punch tool accurately during assembly requires additional time and effort, especially for complex designs or tight tolerances.

According to the principles of the present application, a mechanical spring-back retention configuration and related method for retaining magnets in electric machines is provided. The retention configuration includes a snap member that extends from the rotor and is deflected as a result of insertion of the magnet into the respective rotor slot. The snap has a wedge such that insertion of the magnet causes the wedge to deflect into a gap between the magnet and the rotor slot edge securing the magnet in place. The present configuration provides a spring-back force of the snap and wedge toward the magnet. This combination enables the creation of retention loads in two directions within the gap between the magnet and the edge of the rotor slot. The configurations and methods described herein is applicable to all types of electric machines (electric machine and generator) with magnets.

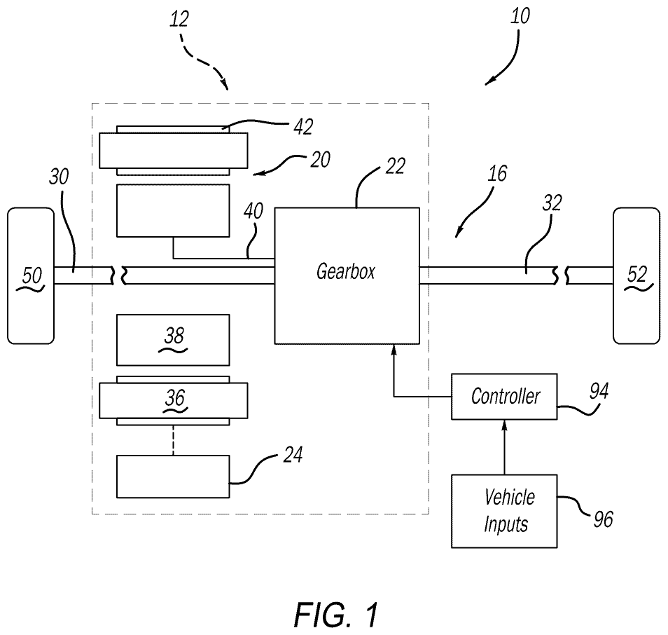

With initial reference to FIG. 1, a vehicle 10 is partially shown in accordance with the principles of the present disclosure. In the example embodiment, vehicle 10 includes an electric drive module (EDM) 12 configured to generate and transfer drive torque to a driveline 16 for vehicle propulsion. The EDM 12 generally includes one or more electric drive units or machines 20 (e.g., electric traction machines), a gearbox assembly 22, and power electronics including a power inverter module (PIM) 24. The electric machine 20 is selectively connectable via the PIM 24 to a high voltage battery system (not shown) for powering the electric machine 20. The gearbox assembly 22 is configured to transfer the generated drive torque to the driveline 16, including a first or left axle shaft 30 and a second or right axle shaft 32. In the example shown, the EDM 12 is configured for use on a rear axle of a two-wheel drive vehicle. It is appreciated however that the EDM 12 can be alternatively configured for use on a front axle of a two-wheel drive vehicle. In other examples an EDM 12 can be provided on both of the front and rear axles for a four-wheel drive or all-wheel drive driveline vehicle.

In the example embodiment, the electric machine 20 generally includes a stator 36, a rotor 38, and a rotor output shaft 40. The stator 36 is fixed (e.g., to a housing 42) and the rotor 38 is configured to rotate relative to the stator 36 to drive the rotor shaft 40 and thus the vehicle axles 30, 32 (e.g., half shafts) and therefore respective drive wheels 50, 52. In the illustrated example, the EDM 12 is configured for a rear axle (axles 30, 32) of the vehicle 10, but it will be appreciated that the systems and methods described herein are equally applicable to a front axle EDM configuration, and can be replicated on the front and rear axles for four wheel drive.

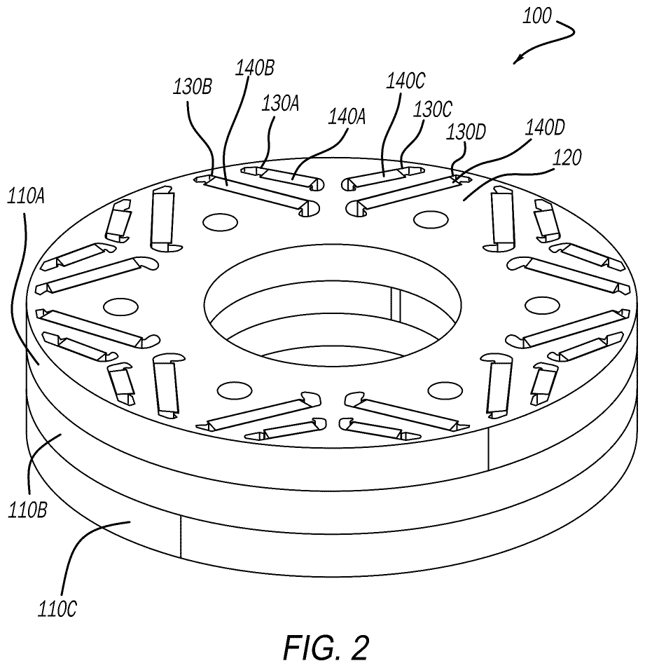

With reference now to FIG. 2, a rotor laminations stack and magnet assembly used in an electric machine of the electric drive module shown in FIG. 1 is shown and generally identified at reference numeral 100. The exemplary rotor laminations stack and magnet assembly 100 includes a first stack 110A, a second stack 110B and a third stack 110C. It is appreciated that more layers may be provided. A rotor lamination assembly 120 can include all of the first, second and third stacks 110A, 110B, 110C and generally defines various pockets or slots 130A, 130B, 130C, 130D, etc. configured to receive complementary magnets 140A, 140B, 140C, 140D, etc. As mentioned above, in prior art arrangements, a mold can be disposed in the slot(s) for retaining the magnet(s).

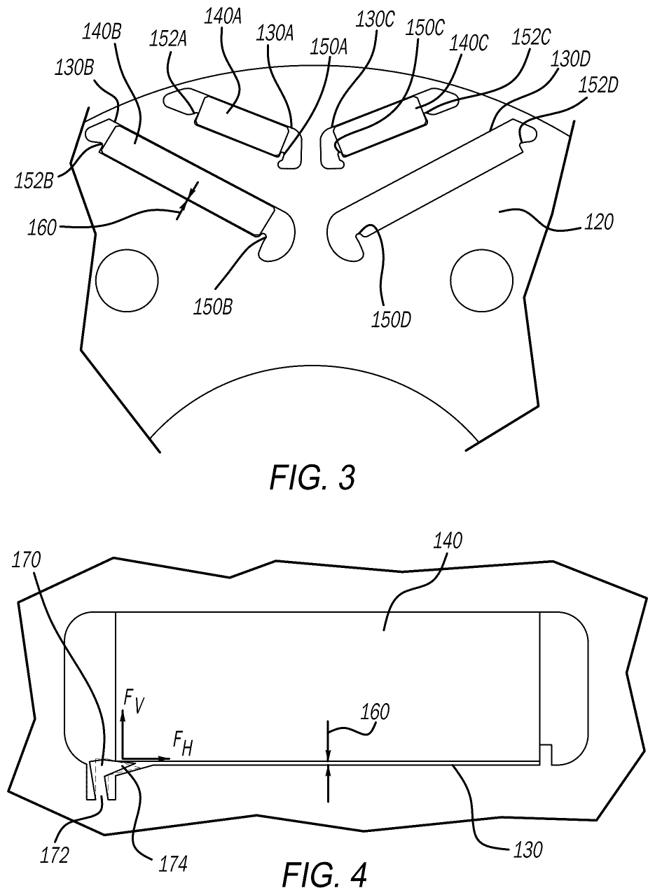

With additional reference to FIGS. 3 and 4, the rotor lamination assembly 120 and magnet assembly 100 will be further described. As will become appreciated, the rotor lamination assembly 120 is made up of a plurality of first laminations having a first pattern and a plurality of second laminations having a second pattern. Various stoppers 150A-150D and 152A-152D are arranged on the rotor lamination assembly 120 that extend generally in a direction into the respective slot(s) 130A, 130B, 130C, 130D, etc. In general, a gap 160 is defined between the respective magnets 140 and rotor lamination 120. FIG. 4 shows a schematic illustration of a snap wedge shaped retention mechanism 170 that is urged between the magnet 140 and the rotor lamination 120 at the gap 160. The wedge shaped retention mechanism 170 generally includes an elongated portion 172 and a main body portion 174. The wedge shaped retention mechanism 170 deflects from a first (pre-magnet insertion) position shown in phantom line, to a second (post-magnet insertion) position, shown in solid line. In the deflected second position, the wedge shaped retention mechanism 170 creates a vertical load F_{V} and a horizontal load F_{H} effectively pushing and retaining the magnet 140 within the rotor slot 130.

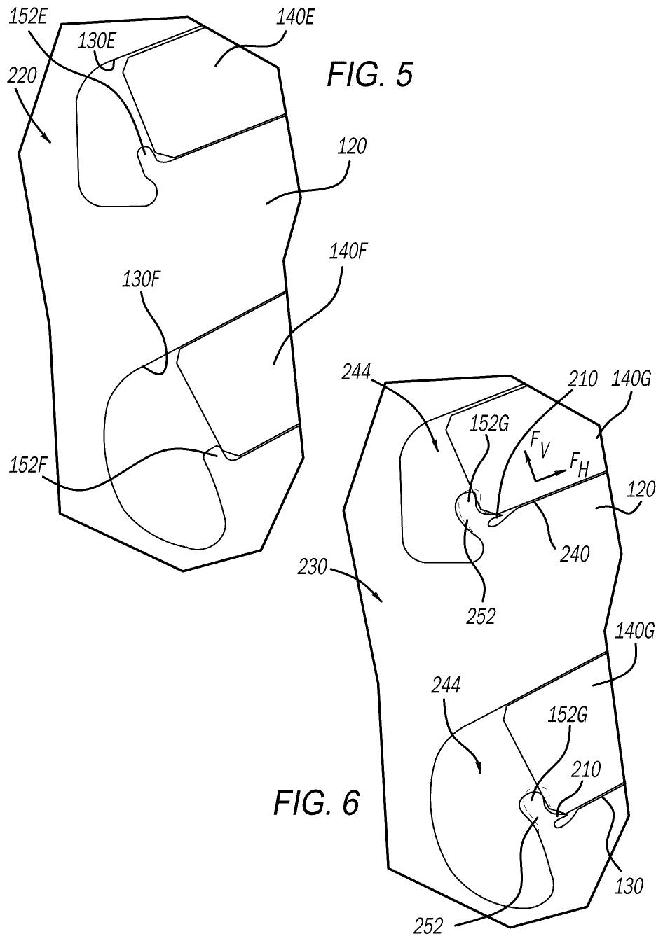

With reference now to FIG. 5, additional features of the present disclosure will be described. FIG. 5 is a plan view of a first lamination pattern 220 in the rotor lamination 120. The first lamination pattern 220 presents a geometry that does not deflect due to insertion of the magnet 140E into the respective slot 130E. In particular, the lamination pattern 220 includes stoppers 152E and 152F that generally extend into the respective slots 130E and 130F that engage respective magnets 140E and 140F. The stoppers 152E and 152F extend into the slots in such a manner that they are not deflected during insertion of the magnets 140E, 140F. As will become appreciated from the following discussion, the lamination layer shown in FIG. 5 is a first lamination that does not include a retention mechanism.

As shown in FIG. 6, a second lamination pattern 230 is provided in the rotor lamination 120. The second lamination 230 presents a geometry that does interface with the magnet 140G during insertion of the magnet 140G into the slot 130. A retention mechanism 152G generally includes a snap retention body 252 and a wedge 210. The magnet 140G deflects a retention mechanism 152G due to slidable advancement of the magnet along the retention mechanism 152G during insertion of the magnet 140G into the slot 130. The magnet 140G interfaces with the retention mechanism 152G in the installed position such that a retention body 252 and a wedge 210 create a load in two directions F_{V} and F_{H} between the magnet 140G and an edge 240 the rotor slot 130.

In examples, the magnet 140G is inserted into a magnet pocket 244, applying load to deform only the retention mechanism 152G associated with the second pattern 230. As shown, the retention mechanism 152G includes the retention body 252 that deflects from a first (pre-magnet insertion) position shown in phantom line, to a second (post-magnet insertion) position, shown in solid line. In general, the deflection of the retention mechanism 152G is due to slidable translation of the magnet 140G along the retention mechanism 152G during insertion of the magnet 140G into the rotor slot 130.

In examples, the retention body 252 acts as a snap wedge that has a natural tendency to return (e.g., “spring-back”) to the phantom line position. In this regard, the retention force is naturally applied from the retention body 252 due to this spring-back tendency. In the deflected second position, the retention body 252 and the wedge 210 creates a vertical load F_{V} and a horizontal load F_{H} effectively pushing and retaining the magnet 140G within the rotor slot 130.

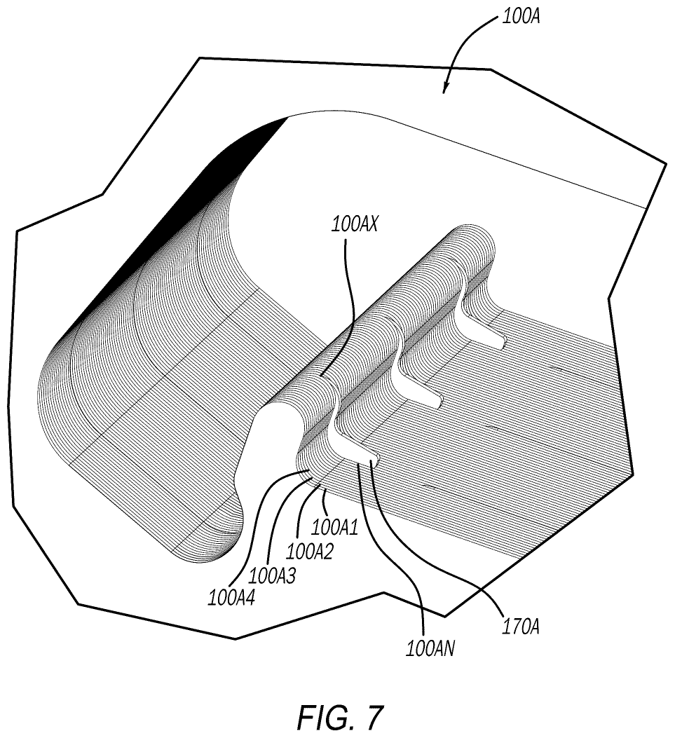

Turning now to FIG. 7, a partial perspective view of a section of a rotor lamination stack 100A is shown. The rotor lamination stack 100A includes a plurality of first lamination layers 100A1, 100A2, 100A3, 100A4, etc. At predetermined intervals, a second rotor lamination layer 100AX is provided. The second rotor lamination 100AX includes a retention mechanism 170A. It is appreciated that the second rotor lamination 100AX can be located only at some of the layers. While three rotor laminations 100AX having the retention mechanism 170A are shown in the example in FIG. 7, other quantities may be provided with the understanding that the second rotor laminations 100AX having the retention mechanism 170A are significantly outnumbered by the first lamination layers 100A1, 100A2, etc. For illustrative purposes, the first lamination layer immediately adjacent to the second lamination 100AX is labelled as 100AN.

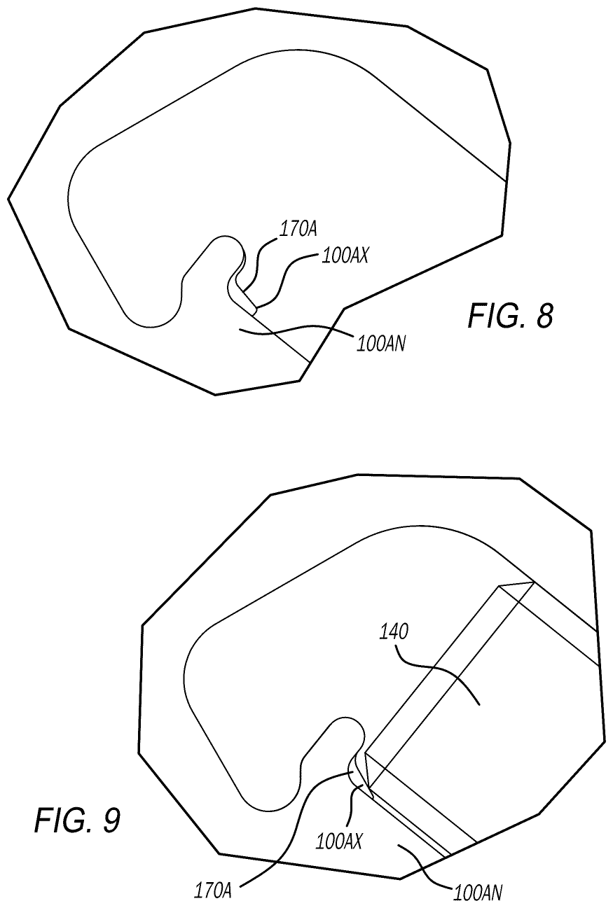

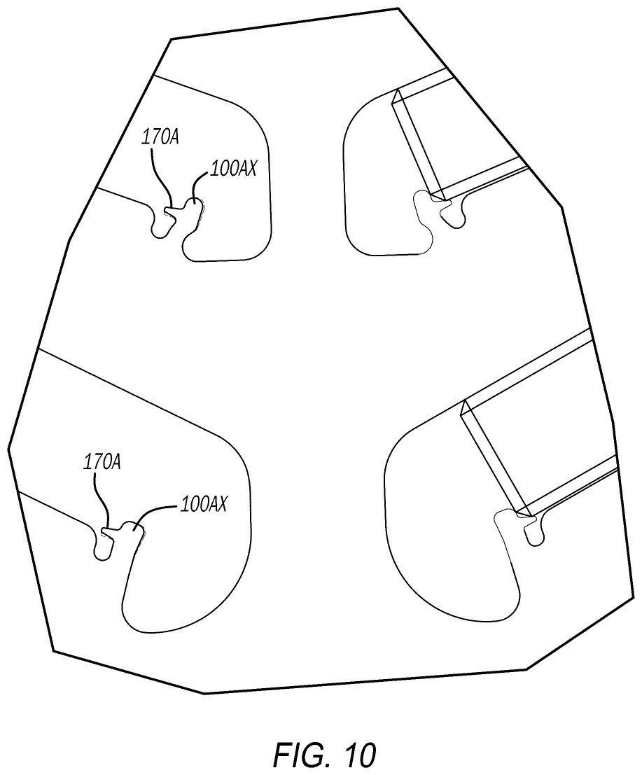

FIG. 8 is a plan view of a first rotor lamination 100AN and a second rotor lamination 100AX showing a retention mechanism 170A disposed on a second rotor lamination 100AX prior to insertion of a magnet 140 in a pre-deformed position. FIG. 9 is a plan view of the first rotor lamination 100AN and second rotor lamination 100AX of FIG. 8 and shown with the retention mechanism 170A disposed on the second rotor lamination 100AX deformed subsequent to insertion of the magnet 140. FIG. 10 is a plan view of a rotor lamination stack shown with the retention mechanism 170A on the second rotor lamination 100AX before deflection in solid line and after deflection (due to magnet interaction) in phantom line.

With the configuration described herein, supplemental retention, such as mold injection is not needed. As can be appreciated, eliminating mold injection is a manufacturing complexity reduction and substantial cost savings.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric machine for powering an electric vehicle, the electric machine comprising:
a rotor configured to rotate relative to a stator to drive a rotor shaft and at least one drive wheel of the electric vehicle, the rotor defining at least a first rotor slot configured to receive a magnet therein, the rotor comprising:
a plurality of first rotor laminations stacked upon each other, each having a first pattern;
a second rotor lamination located between adjacent first rotor laminations of the plurality of first rotor laminations, the second rotor lamination having a second pattern distinct from the first pattern, the second pattern including a retention mechanism defined thereon that extends generally into the first rotor slot; and
wherein the retention mechanism is configured to deflect as a result of engagement with the magnet during insertion of the magnet into the rotor slot creating a retention load onto the magnet in a first direction parallel to the rotor slot and a second direction perpendicular to the rotor slot, the retention load retaining the magnet within the rotor slot.

2. The electric machine of claim 1, wherein the retention mechanism comprises a retention body and the wedge that cooperatively provide the retention load between the magnet and the rotor.

3. The electric machine of claim 2, wherein the second rotor lamination defines an edge at the rotor slot, wherein the retention mechanism deflects from a first pre-magnet insertion position to a second post-magnet insertion position causing the retention load of the magnet against the edge.

4. The electric machine of claim 1, wherein the magnet is inserted into the rotor slot thereby slidably advancing along the retention mechanism causing the retention mechanism to deflect.

5. The electric machine of claim 4, wherein the magnet is shaped such that load is exclusively transmitted onto the retention mechanism of the second rotor lamination and not any of the plurality of first rotor laminations.

6. The electric machine of claim 1, wherein the retention mechanism is a snap wedge mechanism that provides a spring-back force onto the magnet.

7. A method for assembling a rotor configured for use in an electric machine for powering an electric vehicle, the rotor configured to rotate relative to a stator to drive a rotor shaft and at least one drive wheel of the electric vehicle, the rotor defining at least a first rotor slot configured to receive a magnet therein, the method comprising:
arranging a plurality of first rotor laminations stacked upon each other, each having a first pattern;
arranging a second rotor lamination between adjacent first rotor laminations of the plurality of first rotor laminations, the second rotor lamination having a second pattern distinct from the first pattern, the second pattern including a retention mechanism defined thereon that extends generally into the first rotor slot;
inserting a magnet into the rotor slot; and
wherein insertion of the magnet causes the retention mechanism to deflect as a result of engagement with the magnet during insertion of the magnet into the rotor slot creating a retention load onto the magnet in a first direction parallel to the rotor slot and a second direction perpendicular to the rotor slot, the retention load retaining the magnet within the rotor slot.

8. The method of claim 7, wherein the retention mechanism includes a retention body and the wedge that cooperatively provide the retention load between the second magnet and the rotor.

9. The method of claim 8, wherein the rotor lamination defines an edge at the rotor slot, wherein the retention mechanism deflects from a first pre-magnet insertion position to a second post-magnet insertion position causing the retention load of the magnet against the edge.

10. The method of claim 7, wherein the magnet is inserted into the rotor slot thereby slidably advancing along the retention mechanism causing the wedge to deflect.

11. The method of claim 10, wherein the magnet is shaped such that load is exclusively transmitted onto the retention mechanism of the second rotor lamination and not any of the plurality of first rotor laminations.

12. The method of claim 7, wherein the retention mechanism provides a spring-back force onto the magnet.
